(19) United States
(12) Patent Application Publication
(10) Pub. No.: US 2010/0280966 A1
(43) Pub. Date: Nov. 4, 2010

(54) Emissions Trading of Travel Avoidance Through Online Web Conferencing

(75) Inventors: James Powers, Paradise Valley, AZ (US); Ethan Terry Abrams, Phoenix, AZ (US); Marie Prentice, Pasadena, CA (US)

Correspondence Address: Houston IP Department;JACKSON WALKER L.L.P., 1401 McKinney St., Suite 1900, Houston, TX, 77010, US

(73) Assignee: ILINC COMMUNICATIONS, INC.

(21) Appl. No.: 12/785,124

(22) Filed: May 21, 2010

Related U.S. Application Data
(63) Continuation-in-part of application No. 11/818,198, filed on Jun. 13, 2007, now Pat. No. 7,590,690.
Application No. 11/818,198 is a continuation-in-part of application No. 12/317,410, filed on Dec. 23, 2008.
(60) Provisional application No. 61/180,292, filed on May 21, 2009.

(51) Int. Cl. G06Q 10/00; G06F 15/16; G06Q 99/00

(52) U.S. Cl. 705/319; 709/204

(57) ABSTRACT

Online web conferencing methods implemented in an information handling system are provided that determine and display various air emission savings and allowances that result from foregoing physical transportation of users on account of meeting by online web conferences. The air emission allowances generated by the methods herein may be traded in climate exchange markets as desired. Reports may be generated that summarize the quantities determined by the models of the embodiments disclosed herein.

### CROSS-REFERENCE TO RELATED APPLICATION

This patent application claims priority to U.S. Patent Application No. 61/180,292 tiled on May 21, 2009, entitled “Emissions Trading of Travel Avoidance Through Online Web Conferencing.” This patent application is a continuation-in-part of U.S. patent application Ser. No. 11/818,198, filed Jun. 13, 2007, and is a continuation-in-part of U.S. patent application Ser. No. 12/317,410, filed Dec. 23, 2008, both of which are hereby incorporated by reference in their entirety.

### BACKGROUND

The present disclosure generally relates to systems and methods implemented in a computer system for determining quantitative air emission allowances from foregoing physical transportation to a common meeting location through the use of online web conferencing. These quantitative air emission allowances may be transferred, exchanged, or sold to others as desired in climate exchange markets.

### SUMMARY OF THE INVENTION

In one aspect, a method for creating and exchanging emission allowance in a climate exchange market comprises the steps of allowing a plurality of users to forego physical travel to a meeting location by joining a networked online meeting utilizing a user interface across the Internet and determining an air emission allowance based on calculated travel distances of each user to the meeting location. The method further includes the steps of making the emissions allowance available for purchase in a climate exchange market and transferring the emissions allowance to another in the climate exchange market.

### DESCRIPTION OF PREFERRED EMBODIMENTS

The present disclosure generally relates to systems and methods implemented in a computer system for determining quantitative air emission allowances from foregoing physical transportation to a common meeting location through the use of online web conferencing. These quantitative air emission allowances may be transferred, exchanged, or sold to others as desired in climate exchange markets.

Methods implemented in a computer system are provided that determine quantitative benefits from individuals or users foregoing physical transportation to a common meeting location through the use of online web conferencing methods. Various means are employed to determine these benefits and savings, which may then displayed to one or more users. Examples of suitable quantitative savings include, but are not limited to cost savings, productivity savings, environmental savings (e.g. air emission savings or allowances), or any combination thereof.

In this way, by using online meeting technology instead of using conventional transportation to meet at a common physical meeting location, a number of quantitative benefits may be realized and tracked. Advantages of the methods of the present disclosure include, among others, the ability to quantify the savings that result from the use of online meeting technology and the ability to generate individualized and aggregated reports based on one or more online web conferences, seminars, or classes and/or company-wide savings.

Additionally, the air emission savings or allowances determined may then be transferred, sold, or otherwise exchanged to others in a climate exchange market. Examples of climate exchange markets include climate exchange markets such as the Chicago Climate Exchange (CCX) and the European Climate Exchange (ECX).

Specifically, an application provider interface is provided to allow third party computer systems to automatically exchange data with an information handling system such as the information handling system disclosed in co-pending application Ser. No. 12/317,410, which is hereby incorporated by reference in its entirety. As would be understood by persons of skill in the art, credits created as a result of using a web conferencing system to avoid air arc uploaded into an exchange's trading system so that potential buyers of such credits can enter bids to buy the credits.

Upon any trade of the credits on the exchange, the value of the credits could be reported back to the information handling system and displayed in the Green Meter reporting system. The monetary value of the credits may then be calculated such that a user of the information handling system or the Green Meter reporting system would be able to see immediate return on investment and/or trade credit created. In another embodiment, third party software such as government reporting systems or compliance systems receive data regarding the ownership of trade credits generated by use of the Green Meter reporting system and the sale of those credits on an exchange.

In certain embodiments, methods for creating and exchanging emission allowance in a climate exchange market include: (a) allowing a plurality of users to forego physical travel to a meeting location by joining an online meeting; (b) determining an air emission allowance based on calculated travel distances of each user to the meeting location; (c) making the emissions allowance available for purchase in a climate exchange market; and (d) transferring the emissions allowance to another in the climate exchange market.

The Appendix attached hereto is hereby incorporated by reference.

Each of the parameters determined by the information handling system may be stored in memory or displayed to one or more users as desired. Running totals of each of the aforementioned variables of interest may be determined and displayed as desired.

It is recognized that any of the methods herein may be combined with any of the features disclosed in the embodiments in U.S. patent application Ser. No. 11/818,198, filed Jun. 13, 2007, and U.S. patent application Ser. No. 12/317,410, filed Dec. 23, 2008, both of which are hereby incorporated by reference in their entirety.

It is explicitly recognized that one or more methods of the present disclosure may be implemented via an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU or processor) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee.

What is claimed is:

1. A method for creating and exchanging emission allowance in a climate exchange market comprising:
(a) enabling a plurality of users to forego physical travel to a meeting location by joining a networked online meeting utilizing a user interface across the Internet;
(b) determining an air emission allowance based on calculated travel distances of each user to the meeting location;
(c) making the emissions allowance available for purchase in a climate exchange market; and
(d) transferring the emissions allowance to another in the climate exchange market.

2. The method of claim 1 wherein the method is implemented in an information handling system and wherein the networked online meeting is a web conference among the plurality of users.

3. The method of claim 1 further comprising generating a report that summarizes the air emissions allowance that corresponds to the networked online meeting.

4. The method of claim 1 further comprising repeating steps (a)-(b) a plurality of times for a plurality of networked online meetings; and generating a report that summarizes the air emission allowances for the plurality of networked online meetings.

5. The method of claim 1 wherein step the calculated travel distances are determined by:
determining an IP address of each user;
determining an estimated physical location of each user that corresponds to the IP address of each user; and
determining the calculated travel distance as the distance between the estimated physical location and the meeting location.

6. The method of claim 5 wherein the air emission allowance comprises a quantity of greenhouse gas emissions.

7. The method of claim 5 wherein the air emission allowance comprises a quantity of CO₂ emissions.

8. The method of claim 5 wherein the air emission allowance comprises a quantity of NOₓ emissions.

9. The method of claim 5 wherein the air emission allowance comprises a quantity of a plurality of air pollutants.

10. The method of claim 5 wherein the air emission allowance comprises a quantity of a pollutant wherein the pollutant is selected from the group consisting of: carbon dioxide, methane, nitrous oxide, sulfur hexafluoride, perfluorocarbons, hydrofluorocarbons, and any combination thereof.

11. The method of claim 5 wherein the air emission allowance comprises an air emission savings; and wherein the air emission savings corresponds to foregoing a transportation of the calculated travel distance of each user, wherein the air emission allowance is calculated as an automobile emissions calculation when the participant physical location is less than a threshold distance from the session leader physical location and calculated as an aircraft emissions calculation when the participant physical location is greater than the threshold distance.

12. The method of claim 11 wherein the threshold distance is between about 100 to about 200 miles.

13. The method of claim 1 wherein the climate exchange market comprises a market for transferring air emissions allowances and offsets in an air emissions cap and trade program.

14. The method of claim 13 further comprising providing independent verification of the step of determining the air emission allowance.

15. The method of claim 1, further including the step of reporting transfers of emission credits to a regulator.
